(19) United States
(12) Patent Application Publication
(10) Pub. No.: US 2013/0117073 A1
(43) Pub. Date: May 9, 2013

(54) PRICE DETERMINATION SYSTEM, PRICE DETERMINATION SYSTEM CONTROL METHOD, PROGRAM, AND INFORMATION STORAGE MEDIUM

(71) Applicant: Takahiro Sakiyama, Itabashi-ku (JP)

(72) Inventor: Takahiro Sakiyama, Itabashi-ku (JP)

(73) Assignee: KONAMI DIGITAL ENTERTAINMENT CO., LTD., Minato-ku, Tokyo (JP)

(21) Appl. No.: 13/810,987

(22) PCT Filed: Jan. 4, 2012
(86) PCT No.: PCT/JP2012/050037

§ 371 Date: Jan. 18, 2013

(30) Foreign Application Priority Data
Mar. 28, 2011 (JP) 2011-070708

(51) Int. Cl. G06Q 30/02

(52) U.S. Cl. CPC G06Q 30/0206
USPC 705/7.35

(57) ABSTRACT

A price varying unit (32) is varies a current price of purchase target data that is to be purchased by a user. A price determination unit (34) determines, in a case where the first user has purchased the purchase target data, a different price from the current price of the purchase target data which is varied by the price varying unit (32), as a price of the purchase target data which is applied in a case where a second user associated with the first user purchases the purchase target data, based on a price of the purchase target data which was applied in a case where the first user purchased the purchase target data.

### TECHNICAL FIELD

The present invention relates to a price determination system, a control method for a price determination system, a program, and an information storage medium.

### BACKGROUND ART

Up to now, there are known systems (social networking service) for sharing information within a group of users having a friendship with a given user. Patent Literature 1 discloses a social networking service in which, in a case where a user uses a predetermined service, charge processing is executed on the user.

### CITATION LIST

### Patent Literature

Patent Literature 1: JP 2007-206823 A

### SUMMARY OF INVENTION

### Technical Problem

However, in conventional technology, a price of a product or a service (hereinafter referred to simply as “charging service”) that is to be purchased by a user is fixed, and it is not possible to sufficiently increase users who use the charging service. For example, it is conceivable that the users who use the charging service will be increased by lowering the price during a predetermined period, but the price returns to an original price if this period ends, and hence it is not possible to sufficiently increase the users who use the charging service. Therefore, there is a demand for the users who use the charging service to be increased by, for example, making the most of features of a social networking service.

The present invention has been made in view of the above-mentioned problem, and an object thereof is to provide a price determination system, a control method for a price determination system, and a program, which can increase users who use a charging service.

### Solution to Problem

In order to achieve the above-mentioned object, according to the present invention, there is provided a price determination system, including: price varying means for varying a current price of purchase target data that is to be purchased by a user; means for acquiring user group data obtained by associating a first user with a second user from means for storing the user group data; and price determination means for determining, in a case where the first user has purchased the purchase target data, a different price from the current price of the purchase target data which is varied by the price varying means, as a price of the purchase target data which is applied in a case where the second user associated with the first user purchases the purchase target data, based on a price of the purchase target data which was applied in a case where the first user purchased the purchase target data.

Further, according to the present invention, there is provided a control method for a price determination system, the control method including: a price varying step of varying a current price of purchase target data that is to be purchased by a user; a step of acquiring user group data obtained by associating a first user with a second user from means for storing the user group data; and a price determination step of determining, in a case where the first user has purchased the purchase target data, a different price from the current price of the purchase target data which is varied in the price varying step, as a price of the purchase target data which is applied in a case where the second user associated with the first user purchases the purchase target data, based on a price of the purchase target data which was applied in a case where the first user purchased the purchase target data.

Further, according to the present invention, there is provided a program for causing a computer to function as: price varying means for varying a current price of purchase target data that is to be purchased by a user; means for acquiring user group data obtained by associating a first user with a second user from means for storing the user group data; and price determination means for determining, in a case where the first user has purchased the purchase target data, a different price from the current price of the purchase target data which is varied by the price varying means, as a price of the purchase target data which is applied in a case where the second user associated with the first user purchases the purchase target data, based on a price of the purchase target data which was applied in a case where the first user purchased the purchase target data.

Further, according to the present invention, there is provided a non-transitory computer-readable information storage medium having the above-mentioned program recorded thereon.

Further, according to the present invention, there is provided a price determination system including: price varying means for varying a current price of a product or a service that is to be purchased by a user; means for acquiring user group data obtained by associating a first user with a second user from means for storing the user group data; and price determination means for determining, in a case where the first user has purchased the product or the service, a different price from the current price of the product or the service which is varied by the price varying means, as a price of the product or the service which is applied in a case where the second user associated with the first user purchases the product or the service, based on a price of the product or the service which was applied in a case where the first user purchased the product or the service.

According to the present invention, it is possible to increase the users using the charging service.

Further, according to an aspect of the present invention, the price determination means includes price comparison means for comparing, in the case where the second user purchases the purchase target data, the price determined based on the price of the purchase target data which was applied in the case where the first user purchased the purchase target data with the current price of the purchase target data which is varied by the price varying means; and when the current price of the purchase target data which is varied by the price varying means is higher than the price determined based on the price of the purchase target data which was applied in the case where the first user purchased the purchase target data, the price determined based on the price of the purchase target data which was applied in the case where the first user purchased the purchase target data is determined as the price of the purchase target data which is applied in the case where the second user associated with the first user purchases the purchase target data.

Further, according to an aspect of the present invention, the price determination system further includes: means for acquiring sales quantity data relating to a sales quantity or a saleable quantity of the purchase target data from means for storing the sales quantity data; and means for determining a number of second users who are allowed to purchase the purchase target data at the price determined by the price determination means, based on the sales quantity or the saleable quantity indicated by the sales quantity data.

Further, according to an aspect of the present invention, the price determination system further includes: means for acquiring sales quantity data relating to a sales quantity or a saleable quantity of the purchase target data from means for storing the sales quantity data; means for determining a period during which the second user is allowed to purchase the purchase target data at the price determined by the price determination means, based on the sales quantity or the saleable quantity indicated by the sales quantity data.

Further, according to an aspect of the present invention, the price determination system further includes means for executing processing for giving a reward to the first user associated with the second user in the case where the second user purchases the purchase target data at the price determined by the price determination means.

Further, according to an aspect of the present invention, the price determination system further includes means for receiving a designation of a second user by the first user from among the second users associated with the first user, and the price determination means determines the price of the purchase target data which is applied in the case where the second user designated by the first user from among the second users associated with the first user purchases the purchase target data, based on the price of the purchase target data which was applied in the case where the first user purchased the purchase target data.

Further, according to an aspect of the present invention, the price determination system further includes means for acquiring purchase history data indicating a purchase history of the purchase target data by the first user from means for storing the purchase history data, the price determination means includes judgment means for judging based on the purchase history data whether or not, in the case where the second user purchases the purchase target data, the first user associated with the second user has purchased the purchase target data in the past, and when the first user associated with the second user has purchased the purchase target data in the past, the price determined based on the price of the purchase target data which was applied in the case where the first user purchased the purchase target data is determined as the price of the purchase target data which is applied in the case where the second user associated with the first user purchases the purchase target data.

Further, according to an aspect of the present invention, the price determination system further includes purchase qualification generation means for generating, in the case where the first user has purchased the purchase target data, purchase qualification data indicating that the second user associated with the first user is qualified to purchase the purchase target data at the price determined by the price determination means, and causing purchase qualification data storage means to store the purchase qualification data, the price determination means includes judgment means for judging whether or not the purchase qualification data is stored in the purchase qualification data storage means in the case where the second user associated with the first user purchases the purchase target data, and when the purchase qualification data is stored in the purchase qualification data storage means, the price determined based on the price of the purchase target data which was applied in the case where the first user purchased the purchase target data is determined as the price of the purchase target data which is applied in the case where the second user associated with the first user purchases the purchase target data.

### BRIEF DESCRIPTION OF DRAWINGS

FIG. 1 A diagram illustrating an overall configuration of a price determination system according to the present invention.

FIG. 2 A diagram illustrating an example of a screen that allows a user to perform a purchase operation for purchase target data.

FIG. 3 A block diagram illustrating functions realized by the price determination system.

FIG. 4 A diagram illustrating a data storage example of user group data.

FIG. 5 A diagram illustrating a data storage example of purchase target master data.

FIG. 6 A diagram illustrating a data storage example of purchase history data.

FIG. 7 A diagram illustrating a flow of processing performed in the price determination system.

FIG. 8 A diagram illustrating a flow of the processing performed in the price determination system.

FIG. 9 A functional block diagram of a price determination system according to a second embodiment.

FIG. 10 A diagram illustrating a data storage example of purchase qualification data.

FIG. 11 A diagram illustrating a flow of processing performed in the price determination system according to the second embodiment.

FIG. 12 A diagram illustrating a flow of the processing performed in the price determination system according to the second embodiment.

FIG. 13 A diagram illustrating a data storage example of sales quantity data.

FIG. 14 A diagram illustrating association between a condition relating to a sales quantity of the purchase target data and a purchase enabled user number.

FIG. 15 A diagram illustrating a data storage example of purchase history data according to a third embodiment.

FIG. 16 A diagram illustrating association between the condition relating to the sales quantity of the purchase target data and a purchase enabled period.

FIG. 17 A diagram illustrating a data storage example of purchase history data according to a fourth embodiment.

FIG. 18 A diagram illustrating a data storage example of purchase history data according to a sixth embodiment.

### DESCRIPTION OF EMBODIMENTS

### 1. First Embodiment

In the following, embodiments according to the present invention are described in detail with reference to the accompanying drawings. A price determination system according to the present invention determines a price of purchase target data whose price varies under a predetermined condition. The purchase target data represents data to be purchased by a user as a product, for example, data to be given to the charged user. In this embodiment, the description is directed to a case where the user purchases application software (for example, game software) as an example of the purchase target data.

[1-1. Overall Configuration of Price Determination System]

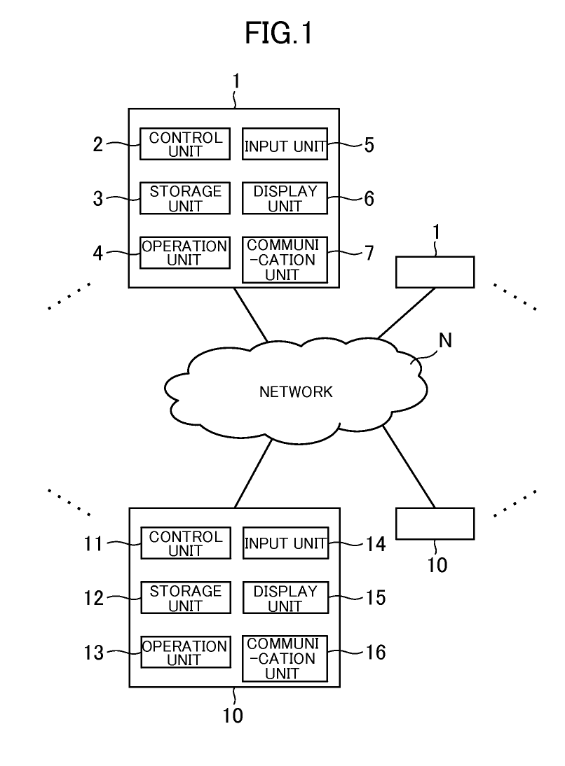

FIG. 1 is a diagram illustrating an overall configuration of the price determination system according to the present invention. As illustrated in FIG. 1, a price determination system S includes, for example, one or a plurality of server devices 1 managed by a system administrator, and one or a plurality of user devices 10 to be subjected to the users' operations. The respective devices that are included in the price determination system S are connected to each other so as to be able to perform data communication via a network N.

The server device 1 is a known server computer. For example, the server device 1 includes a control unit 2 including a CPU, a storage unit 3 including an HDD and a RAM, an operation unit 4 including a keyboard and a mouse, an input unit 5 including a DVD reproducing device, a display unit 6 including a liquid crystal monitor, and a communication unit 7 including a network card.

The control unit 2 controls each of the units of the server device 1 according to an operating system stored in the storage unit 3, a program read from the input unit 5, and the like. The storage unit 3 stores various programs, various kinds of data (for example, data indicating the current date and time), and the like. The operation unit 4 inputs various operation signals to the control unit 2. The input unit 5 reads data, programs, and the like from various storage media. The communication unit 7 performs communication with another terminal via the network N.

The user device 10 is a known computer such as a personal computer, a game machine (such as consumer game machine or portable game machine), or a personal digital assistant (for example, mobile phone). For example, the user device 10 includes a control unit 11 including a CPU, a storage unit 12 including a flash memory and a RAM, an operation unit 13 including a touch panel and various buttons, an input unit 14 including a memory card slot, a display unit 15 including a liquid crystal panel, and a communication unit 16 including a network card for performing wireless communication or wired communication.

The control unit 11 executes, for example, various programs stored in the storage unit 12. The storage unit 12 stores data necessary for executing programs, data indicating current date and time, and the like. The operation unit 13 inputs various operation signals to the control unit 11. The input unit 14 reads programs and data from the various storage media. The communication unit 16 performs communication with another terminal via the network N.

For example, the user operates the user device 10 to use a social networking service for sharing information with another user they have a friendship with. The “user having a friendship with a given user” is the same meaning as the user associated with a given user.

The user can communicate with another user they have a friendship with by using the social networking service. For example, the user operates the user device 10 to register data indicating their own diary on the server device 1. This diary can be viewed only by the user having a friendship with the user who has registered the diary. Note that various known methods can be applied as a method that allows a user to communicate with another user in the social networking service.

In this embodiment, the user can purchase the purchase target data by operating the user device 10. The user can purchase, for example, application software such as game software, word processor software, spreadsheet software, or graphics editing software. The user can perform a purchase operation for the purchase target data through a predetermined screen.

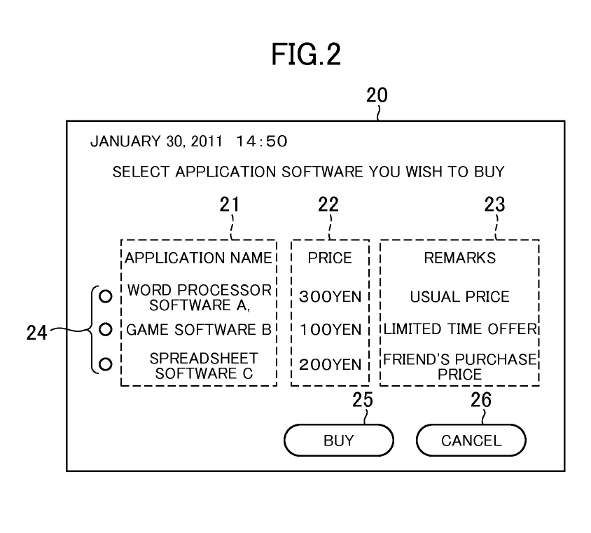

FIG. 2 is a diagram illustrating an example of a screen that allows the user to perform the purchase operation for the purchase target data. As illustrated in FIG. 2, displayed on a purchase screen 20 are a list 21 showing candidates for the purchase target data that can be purchased by the user, a price 22 showing a charge amount applied in the case where the user purchases the purchase target data, a remarks column 23 showing contents of the purchase target data, descriptions on the prices, and the like, buttons 24 that allow the user to select the purchase target data, a button 25 that allows the user to instruct purchase of the purchase target data, and a button 26 for canceling the purchase of the purchase target data. The user performs the purchase operation for the purchase target data depending on display contents of the purchase screen 20.

The purchase target data has the current price varying under a predetermined condition. In this embodiment, the description is directed to a case where the current price of the purchase target data becomes low when a given period is reached. In other words, during the period (hereinafter referred to as “limited time sale period”) during which the price of the purchase target data is low, the user can purchase the purchase target data at a lower price (hereinafter referred to as “discount price”) than a usual price.

In the case illustrated in FIG. 2, “Word processor software A” is sold at the usual price, while “Game software B” is sold at the discount price. When the limited time sale period ends, “Game software B” returns to the usual price.

The price determination system S according to this embodiment is configured so that, for example, if a given user has purchased the purchase target data at the discount price, the user having a friendship with the given user can purchase the purchase target data at the discount price instead of the usual price even after the limited time sale period ends. For example, in the case illustrated in FIG. 2, “Spreadsheet software C”, for which the limited time sale period has expired, has been purchased by a friend of the user within the limited time sale period in the past, and hence this user can purchase “Spreadsheet software C” at the discount price. This technology is hereinafter described in detail.

[1-2. Functional Blocks]

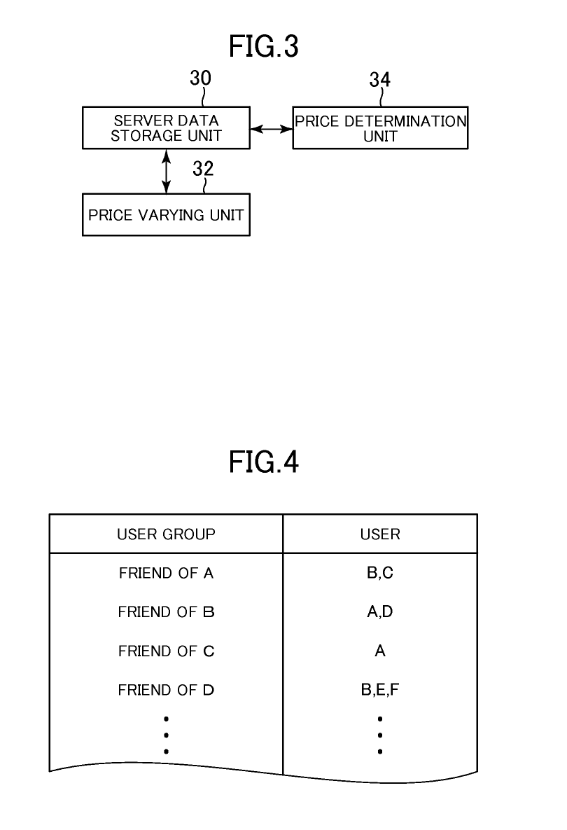

FIG. 3 is a block diagram illustrating functions realized by the price determination system S. As illustrated in FIG. 3, the price determination system S realizes a server data storage unit 30, a price varying unit 32, and a price determination unit 34. In this embodiment, the description is directed to a case where the server data storage unit 30, the price varying unit 32, and the price determination unit 34 are realized by the server device 1. On the server device 1, those functions are realized by the control unit 2 operating in accordance with the program read from the storage unit 3.

[1-2-1. Server Data Storage Unit]

The server data storage unit 30 is realized mainly by the storage unit 3. The server data storage unit 30 stores data that is necessary for the user to use the social networking service and data that is necessary for the user to purchase the purchase target data. For example, the server data storage unit 30 stores the following data:

(1) user data for uniquely identifying the user;
(2) user group data obtained by associating a given user (first user) with another user (second user);
(3) purchase target master data for defining the purchase target data that can be purchased by the user; and
(4) purchase history data indicating a purchase history of the purchase target data by the given user (first user).

[User Data]

The user data stores, for example, personal information on the user. The personal information on the user includes, for example, a user ID, a password, the user's full name, sex, birth date, address, and contact information (such as telephone number or e-mail address), and information for charging the user (for example, information indicating a credit card number or a bank account).

For example, when starting the use of the social networking service, the user performs user registration by inputting the contents to be stored in the user data. Further, when the user uses the social networking service after having performed the user registration, the server device 1 performs authentication of the user by acquiring the user ID and the password that are input by the user from the user device 10.

[User Group Data]

FIG. 4 is a diagram illustrating a data storage example of the user group data. As illustrated in FIG. 4, the user group data stores information for identifying a user group and users belonging to the user group in association with each other. The user group defines one or a plurality of users associated with a given user. In this embodiment, the user group defines, for example, the user (hereinafter referred to simply as “friend”) having a friendship with the given user. The user can share information with one or a plurality of users belonging to the user group.

[Purchase Target Master Data]

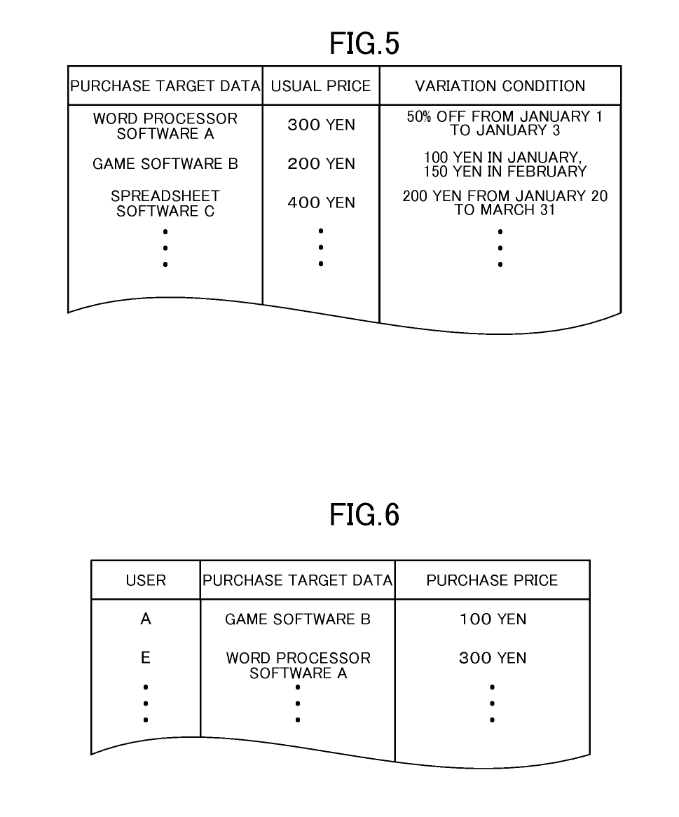

FIG. 5 is a diagram illustrating a data storage example of the purchase target master data. As illustrated in FIG. 5, the purchase target master data stores data for identifying the purchase target data, data indicating the usual price (reference price) of the purchase target data, and a variation condition for varying the current price of the purchase target data, in association with one another.

The variation condition represents a condition indicating whether or not the current price of the purchase target data varies. As the variation condition, any condition that is previously defined suffices. In this embodiment, the description is directed to a case where the variation condition is a condition (for example, data indicating the limited time sale period) relating to a current time point. Note that although described in detail in a modified example, the variation condition may be a condition relating to a current sales quantity of the purchase target data or another such condition.

Further, in this embodiment, the description is directed to a case where the purchase target master data stores data relating to a price of the purchase target data which is applied in a case where the variation condition is satisfied. In other words, the variation condition is associated with the price of the purchase target data which is applied in the case where the variation condition is satisfied.

For example, in the case where the variation condition is satisfied, the user can purchase the purchase target data at a lower discount price than the usual price. Further, with a plurality of variation conditions prepared, the price of the purchase target data may differ depending on the satisfied variation condition. For example, a discount rate of the purchase target data may differ depending on the satisfied variation condition. For example, in the case of the data storage example illustrated in FIG. 5, the price of “Game software B” is 200 yen from March until December, while varying to 100 yen during January and varying to 150 yen during February.

[Purchase History Data]

FIG. 6 is a diagram illustrating a data storage example of the purchase history data. As illustrated in FIG. 6, the purchase history data stores, for example, data for identifying the user, data for identifying the purchase target data that has been purchased by the user, and price data indicating the price of the purchase target data which was applied in the case where the user purchased the purchase target data. In other words, the purchase history data stores information relating to the purchase target data that has been purchased by the given user in the past.

The price within the purchase history data which is applied in the case where the user has purchased the purchase target data represents a price applied when the user purchased the purchase target data, and is an amount of money charged to the user who purchased the purchase target data. In this embodiment, as the price data stored in the purchase history data, data indicating any one of the usual price and the discount price applied on limited time sale is stored.

In this embodiment, the description is directed to a case where the price data indicates the price of the purchase target data itself, but the price data may be any data that relates to the price of the purchase target data which is applied in the case where the given user purchases the purchase target data, and may alternatively indicate, for example, the discount rate.

Note that the control unit 2 functions as means for acquiring various kinds of data stored in the server data storage unit 30. Further, the data stored in the server data storage unit 30 is not limited to the above-mentioned example, and any data that is necessary for the user to use the social networking service or any data that is necessary for the user to purchase the purchase target data may be stored. In addition, for example, the server data storage unit 30 may store data indicating the current time point, data indicating a diary and an image registered by the user, or the purchase target data itself.

[1-2-2. Price Varying Unit]

The price varying unit 32 is realized mainly by the control unit 2. The price varying unit 32 varies (increases or decreases) the current price of the purchase target data that is to be purchased by the user. As described above, data indicating the price before variation (usual price) of the purchase target data is stored in, for example, the server data storage unit 30. The price varying unit 32 varies the current price of the purchase target data by varying the price (usual price) indicated by this data.

For example, the price varying unit 32 judges whether or not the variation condition is satisfied, and varies the current price of the purchase target data based on a judgment result thereof. In this embodiment, it is judged based on the data indicating the current time point whether or not the variation condition is satisfied.

For example, when the variation condition is satisfied, the price varying unit 32 varies the current price of the purchase target data so as to become the price associated with the variation condition. In this embodiment, the price varying unit 32 judges whether or not the current time point falls within the limited time sale period, and when the current time point falls within the limited time sale period, varies the current price of the purchase target data to the discount price.

[1-2-3. Price Determination Unit]

The price determination unit 34 is realized mainly by the control unit 2. In a case where a first user has purchased the purchase target data, the price determination unit 34 determines a price which is varied by the price varying unit 32 and is different from the current price of the purchase target data, as the price of the purchase target data which is applied in a case where a second user associated with the first user purchases the purchase target data (hereinafter referred to simply as “purchase price of the second user”), based on the price of the purchase target data which was applied in the case where the first user purchased the purchase target data (in other words, price indicated by the price data; hereinafter referred to simply as “purchase price of the first user”).

For example, the price determination unit 34 acquires the price data from the server data storage unit 30, and determines the purchase price of the second user based on the price data. For example, the price determination unit 34 determines the purchase price of the second user so that the purchase price of the second user becomes the price corresponding to the price of the purchase target data which was applied in the case where the first user associated with the second user purchased the purchase target data.

The price corresponding to the purchase price of the first user represents the price determined based on the purchase price of the first user and, for example, is the same price as the purchase price of the first user. In addition, for example, the price corresponding to the purchase price of the first user may be a price defined based on the current price varied by the price varying unit 32 and the purchase price of the first user (for example, average price thereof) or may be a price obtained by substituting the purchase price of the first user into a predetermined numerical expression (for example, price that is 1.1 times the purchase price of the first user).

In a case where the first user associated with the second user has not purchased the purchase target data in the past, the price determination unit 34 determines the purchase price of the second user based on the current price varied by the price varying unit 32. On the other hand, in the case where the first user associated with the second user has purchased the purchase target data in the past, the price determination unit 34 inhibits the purchase price of the second user from being determined as the current price varied by the price varying unit 32, and determines the purchase price of the second user based on the price data.

Further, in this embodiment, the description is directed to a case where the price determination unit 34 includes price comparison means for comparing, in the case where the second user purchases the purchase target data, the price determined based on the purchase price of the first user (in other words, price determined based on the price data) with the current price of the purchase target data which is varied by the price varying unit 32.

In this case, the price determination unit 34 determines the purchase price of the second user based on a comparison result from the price comparison means. For example, when the current price of the purchase target data which is varied by the price varying unit 32 is higher than the purchase price of the first user, the price determined based on the purchase price of the first user is determined as the purchase price of the second user associated with the first user. In other words, the purchase price of the second user is determined based on the price data. On the other hand, when the current price of the purchase target data which is varied by the price varying unit 32 is lower than the purchase price of the first user, the current price of the purchase target data which is varied by the price varying unit 32 is determined as the purchase price of the second user.

Further, for example, it is judged based on a predetermined method whether or not the second user is qualified to purchase the purchase target data at the price determined by the price determination unit 34 (for example, purchase price of the first user). In other words, it is judged based on the predetermined method whether or not the given user can purchase the purchase target data at the price determined by the price determination unit 34. The price determination unit 34 may determine the price of the purchase target data based on a judgment result thereof.

In other words, when the second user is qualified to purchase the purchase target data at the price determined by the price determination unit 34, the price determination unit 34 determines the purchase price of the second user based on the price data. In this embodiment, for example, judgment processing thereof is executed by the following method.

For example, in the following, the description is directed to a case where the price determination unit 34 includes judgment means for judging, in the case where the second user purchases the purchase target data, based on the purchase history data, whether or not the first user associated with the second user has purchased the purchase target data in the past. The judgment means refers to the user group data to identify the first user associated with the second user, and performs the above-mentioned judgment by referring to the purchase history of the identified first user among purchase histories indicated by the purchase history data.

Further, in this case, the price determination unit 34 determines the purchase price of the second user based on a judgment result from the judgment means. In the case where the first user associated with the second user has purchased the purchase target data in the past, the price determination unit 34 determines the price determined based on the purchase price of the first user, as the purchase price of the second user associated with the first user.

In other words, for example, when it is judged that the first user associated with the second user has purchased the purchase target data in the past, the second user is qualified to purchase the purchase target data at the price determined by the price determination unit 34, and hence the purchase price of the second user is determined based on the price data.

On the other hand, for example, when it is not judged that the first user associated with the second user has purchased the purchase target data in the past, the second user is not qualified to purchase the purchase target data at the price determined by the price determination unit 34, and hence the purchase price of the second user is inhibited from being determined based on the price data. In this case, the purchase price of the second user is determined as the current price varied by the price varying unit 32.

[1-3. Flow of Processing Performed in Price Determination System]

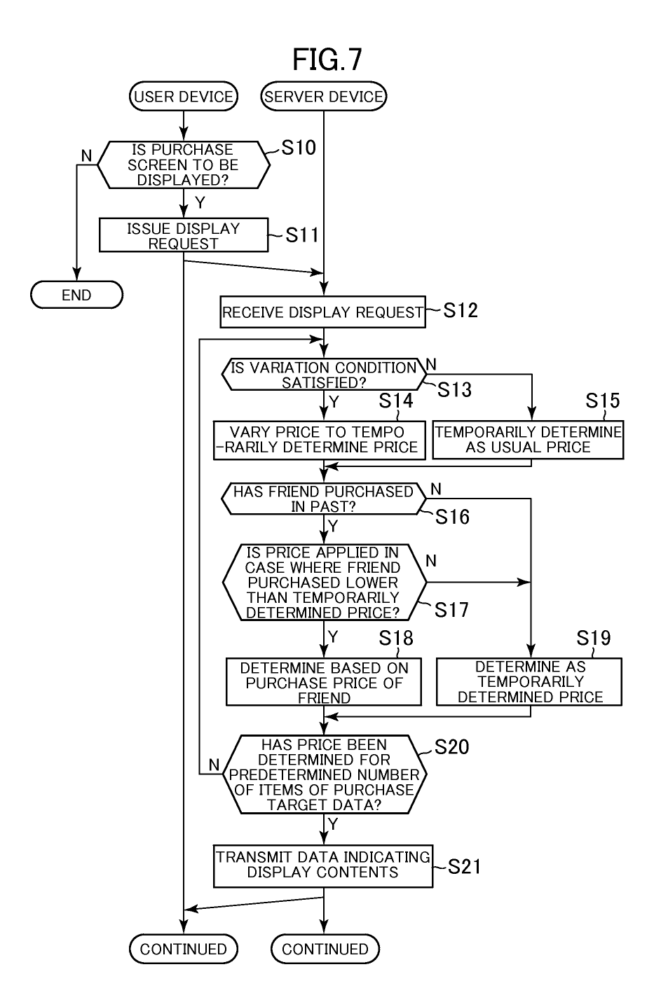

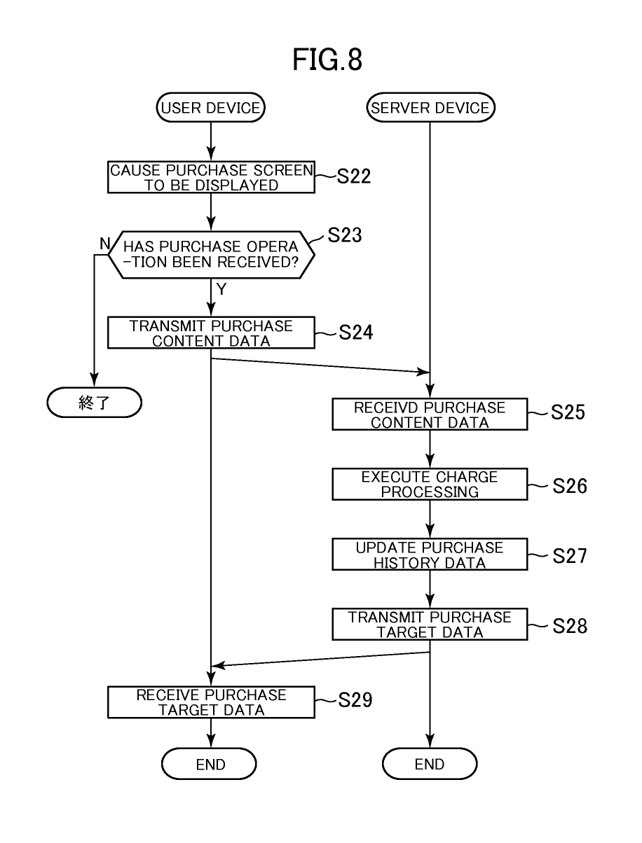

FIGS. 7 and 8 are diagrams illustrating the flow of processing performed in the price determination system S. The processing described below is executed, for example, by the control unit 2 operating in accordance with the program stored in the storage unit 3 or the like and the control unit 11 operating in accordance with the program stored in the storage unit 12 or the like. Note that in execution of the processing illustrated in FIGS. 7 and 8, the user inputs the user ID and the password, and the authentication of the user is performed. In other words, the server device 1 retains information for identifying which user has accessed that server device 1.

As illustrated in FIG. 7, the control unit 11 first judges whether or not the display unit 15 is to display the purchase screen 20 that allows the user to purchase the purchase target data (S10). For example, it is judged whether or not a predetermined button has been depressed through a predetermined menu screen. When it is not judged that the display unit 15 is to display the purchase screen 20 (S10; N), the control unit 11 ends this processing.

When it is judged that the display unit 15 is to display the purchase screen 20 (S10; Y), the control unit 11 issues a display request for the purchase screen 20 to the server device 1 (S11). In other words, a request to acquire data indicating a list of the purchase target data that can be purchased by the user is issued. Note that when the display request is issued in Step S11, the information (for example, user ID) for identifying the user may be transmitted to the server device 1 as well.

On the server device 1, the control unit 2 receives the display request for the purchase screen 20 (S12). The control unit 2 sequentially refers to records of the purchase target master data to judge whether or not the variation condition stored in the purchase target master data is satisfied (S13). In Step S13, for example, it is judged whether or not the current time point falls within the limited time sale period.

When it is judged that the variation condition is satisfied (S13; Y), the control unit 2 varies the price of the purchase target data to temporarily determine the price of the purchase target data (S14). In Step S14, for example, the price of the purchase target data varies from the usual price to the discount price. In other words, for example, the price of the purchase target data varies to the discount price associated with the variation condition judged as being satisfied in Step S13.

On the other hand, when it is not determined that the variation condition is satisfied (S13; N), the control unit 2 avoids varying the price of the purchase target data to the discount price, and temporarily determines the price of the purchase target data as the usual price (S15). Note that, data indicating the price temporarily determined in Step S14 or S15 is temporarily stored in the RAM or the like of the storage unit 3 in association with the information for identifying the purchase target data.

The control unit 2 refers to the user group data and the purchase history data to judge whether or not the friend (first user) of the user (second user) who has issued the display request for the purchase screen 20 has purchased the purchase target data in the past (S16). In Step S16, the friend is identified based on the user group data. Then, it is judged based on the purchase history data whether or not this friend has purchased in the past the purchase target data that is currently being subjected to determination processing for the price (processing of S13 to S19).

When it is judged that the friend of the user has purchased in the past (S16; Y), the control unit 2 refers to the price data stored in the purchase history data to judge whether or not the price (in other words, purchase price of the first user) which was applied in the case where the friend purchased the purchase target data is lower than the price temporarily determined in Step S14 or S15 (S17). In other words, the purchase price of the friend which is indicated by the price data stored in the purchase history data is compared with the current price temporarily determined in Step S14 or S15.

When it is judged that the purchase price of the friend is lower (S17; Y), the control unit 2 determines the purchase price of the user (in other words, purchase price of the second user) who issued the display request in Step S11 based on the purchase price of the friend (in other words, purchase price of the first user) which is indicated by the price data (S18).

On the other hand, when it is not judged that the friend of the user has purchased in the past (S16; N) and when it is not judged that the purchase price of the friend is lower (S17; N), the control unit 2 determines the purchase price of the user who issued the display request in Step S11 as the price temporarily determined in Step S14 or S15 (S19). Data indicating the price determined in Step S18 or S19 is stored in the RAM or the like of the storage unit 3 in association with the information for identifying the purchase target data.

Note that in addition to the above-mentioned storage contents, the storage unit 3 may be associated with a flag indicating that the price was determined in Step S18 based on the purchase price of the friend or a flag indicating the fact of being the discount price. With reference to this flag, the fact of being the purchase price of the friend, the fact of being the discount price applied during the limited time sale period, or another such fact can be displayed in the remarks column 23 of the purchase screen 20.

The control unit 2 judges whether or not the price has been determined for a predetermined number of items of purchase target data (S20). The predetermined number may be, for example, the number of items of purchase target data that are displayed on the purchase screen 20 for which the display request has been issued or the number of items of purchase target data that are stored in the purchase target master data.

When it is not judged that the price has been determined for the predetermined number of items of purchase target data (S20; N), the processing returns to Step S13 to determine the price of the subsequent item of purchase target data. When it is judged that the price has been determined for the predetermined number of items of purchase target data (S20; Y), the control unit 2 generates data indicating the display contents of the purchase screen 20 based on the price of the purchase target data determined in Step S18 or S19, and transmits the data to the user device 10 (S21).

Referring next to FIG. 8, on the user device 10, the control unit 11 causes the display unit 15 to display the purchase screen 20 based on the data received from the server device 1 (S22). In Step S22, the purchase screen 20 including the list 21 indicating the purchase target data that can be purchased by the user and the price 22 of the purchase target data determined in Step S18 or S19 is displayed. When being displayed, the purchase screen 20 waits for the purchase operation performed by the user.

The control unit 11 judges whether or not the purchase operation for the purchase target data has been received from the purchase screen 20 (S23). For example, it is judged whether or not the buttons 24 corresponding to one or a plurality of items of purchase target data have been selected and the button 25 has been depressed. When it is not judged that the purchase operation for the purchase target data has been received (S23; N), this processing is brought to an end.

When it is judged that the purchase operation for the purchase target data has been received (S23; Y), the control unit 11 transmits purchase content data including data for identifying the purchase target data selected by the user to the server device 1 (S24). In addition, the purchase content data may include data for identifying the user who has performed the purchase operation or data indicating date/time at which the purchase operation was performed.

On the server device 1, the control unit 2 receives the purchase content data from the user device 10 (S25). The received purchase content data is temporarily stored in, for example, the RAM or the like of the storage unit 3.

The control unit 2 executes the charge processing on the user who has performed the purchase operation based on the user data and the purchase target data (S26). In Step S26, with reference to the data indicating the price determined in Step S18 or S19, the price of the purchase target data that is indicated by the purchase content data is identified. The identified price is charged to the user. As a charging method, a credit card number stored in the user data may be used, processing of charging by proxy may be executed through the intermediation of a mobile phone carrier, or various known methods can be applied.

The control unit 2 updates the storage contents of the purchase history data (S27). In Step S27, the storage contents of the purchase history data are updated by, for example, adding a new record to the purchase history data based on the data for identifying the user who has purchased the purchase target data, the data for identifying the purchase target data that has been purchased by the user, and data indicating the purchase price of the user (in other words, data indicating the amount of money charged to the user).

The control unit 2 transmits the purchase target data for which the user has performed the purchase operation to the user (S28). On the user device 10, the control unit 11 receives the purchase target data that has been transmitted by the server device 1, and causes the storage unit 12 to store the data (S29), which brings the processing to an end.

According to the price determination system S described above, in the case where the given user (second user) purchases the purchase target data, this user can purchase the purchase target data at the price corresponding to the purchase price of the friend (first user). For example, even if the given user has missed the limited time sale period, if the friend has purchased game software at the discount price during the limited time sale period, this user can purchase the game software at the discount price instead of the usual price. Accordingly, such a feature of the social networking service that the users are associated with each other can be made the most of to increase the users who use a charging service.

Further, the price is determined by comparison between the current price and the purchase price of the friend, and hence the user can purchase the purchase target data at the purchase price of the friend when the purchase price of the friend is lower than the current price. In other words, for example, when the current price has become even lower than the discount price at which the friend purchased during the limited time sale period, the user can purchase not at the purchase price of the friend but at the lower current price.

Further, by referring to the purchase history data, it is possible to judge whether or not the friend of the user performing the purchase operation has purchased the purchase target data in the past. In other words, it is possible to judge whether or not the user performing the purchase operation has a friendship with the user who has purchased the purchase target data in the past and is qualified to purchase the purchase target data at the discount price. For example, the user purchasing the purchase target data, who has a friendship with the user who has purchased the purchase target data in the past at a time point of performing the purchase operation, can purchase the purchase target data at the purchase price of this user.

Note that in a first embodiment, the description is directed to the case where all friends of the user who has purchased the purchase target data at the discount price in the past are qualified to purchase the purchase target data at the price determined by the price determination unit 34, but the number of users who are qualified to purchase the purchase target data at the price determined by the price determination unit 34 (hereinafter referred to as “purchase enabled user number”) may be defined in advance. For example, the first five friends of the user who has purchased the purchase target data may be allowed to purchase the purchase target data at the price determined by the price determination unit 34.

### 2. Second Embodiment

In the first embodiment, the description is directed to the case where it is judged, based on the purchase history data, whether or not the user (second user) who is going to purchase the purchase target data is qualified to purchase the purchase target data at the purchase price of another user (first user), but this judgment processing may be executed by another method.

A price determination system S according to a second embodiment is configured so that the above-mentioned judgment processing is performed based on whether or not purchase qualification data described later is associated with the user who is going to purchase the purchase target data. In the following, the technology according to the second embodiment is described in detail.

[2-1. Functions Realized in Second Embodiment]

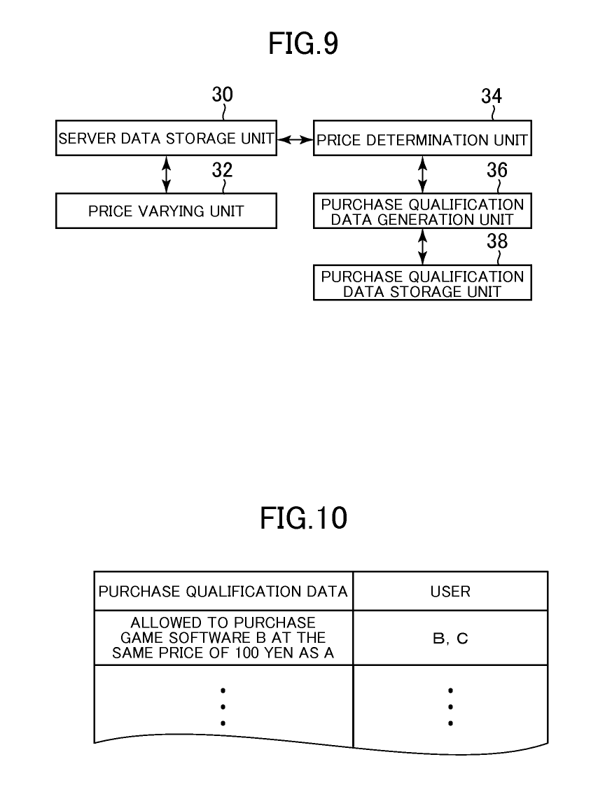

FIG. 9 is a functional block diagram of the price determination system S according to the second embodiment. As illustrated in FIG. 9, the price determination system S according to the second embodiment realizes a purchase qualification data generation unit 36 and a purchase qualification data storage unit 38 in addition to the functions according to the first embodiment. In the following, the description is directed to a case where the purchase qualification data generation unit 36 and the purchase qualification data storage unit 38 are realized by the server device 1.

[2-1-1. Purchase Qualification Data Generation Unit]

The purchase qualification data generation unit 36 is realized mainly by the control unit 2. In a case where the first user has purchased the purchase target data, the purchase qualification data generation unit 36 generates the purchase qualification data indicating that the second user associated with the first user is qualified to purchase the purchase target data at the price determined by the price determination unit 34, and causes the purchase qualification data storage unit 38 to store the purchase qualification data.

The purchase qualification data represents data for proving to the price determination unit 34 that the second user is qualified to purchase the purchase target data at the price determined by the price determination unit 34 (for example, purchase price of the first user). In this embodiment, the description is directed to a case where the purchase qualification data includes, for example, the price data or data indicating the price defined based on the price data. In other words, the description is directed to a case where the purchase qualification data indicates the purchase price of the first user or the price at which the second user can purchase.

[2-1-2. Purchase Qualification Data Storage Unit]

The purchase qualification data storage unit 38 is realized mainly by the storage unit 3. The purchase qualification data storage unit 38 stores the purchase qualification data generated by the purchase qualification data generation unit 36. In this embodiment, the purchase qualification data is stored in association with the second user.

FIG. 10 is a diagram illustrating a data storage example of the purchase qualification data. As illustrated in FIG. 10, the purchase qualification data generated by the purchase qualification data generation unit 36 is stored in the purchase qualification data storage unit 38 in association with the second user. In other words, the purchase qualification data generated in the case where the given user purchases the purchase target data is stored in the purchase qualification data storage unit 38 in association with data for identifying the friend of this user.

For example, in the case where the first user has purchased the purchase target data, the purchase qualification data generation unit 36 refers to the user group data to identify the second user associated with this first user. The information for identifying this identified second user and the generated purchase qualification data are stored in the purchase qualification data storage unit 38 in association with each other.

The price determination unit 34 according to the second embodiment includes judgment means for judging, in the case where the second user associated with the first user purchases the purchase target data, whether or not the purchase qualification data is stored in the purchase qualification data storage unit 38. In other words, in the case where the second user purchases the purchase target data, the price determination unit 34 judges whether or not the purchase qualification data is stored in the purchase qualification data storage unit 38, to thereby judge whether or not this second user is qualified to purchase the purchase target data at the price determined by the price determination unit 34.

The price determination unit 34 determines the purchase price of the second user based on the judgment result from the judgment means. In other words, when the purchase qualification data is stored in the purchase qualification data storage unit 38, the price determination unit 34 determines the price determined based on the purchase price of the first user as the purchase price of the second user associated with the first user. On the other hand, when the purchase qualification data is not stored in the purchase qualification data storage unit 38, the price determination unit 34 determines the current price varied by the price varying unit 32 as the purchase price of the second user.

Further, in the following, the description is directed to a case where, in the case where the second user purchases the purchase target data, the judgment means of the price determination unit 34 judges whether or not the purchase qualification data and the second user are stored in the purchase qualification data storage unit 38 in association with each other. In other words, in the case where the second user purchases the purchase target data, when the purchase qualification data and the second user are stored in the purchase qualification data storage unit 38 in association with each other, it is judged that this second user is qualified to purchase the purchase target data at the purchase price of the first user.

[2-2. Flow of Processing Performed in Price Determination System According to Second Embodiment]

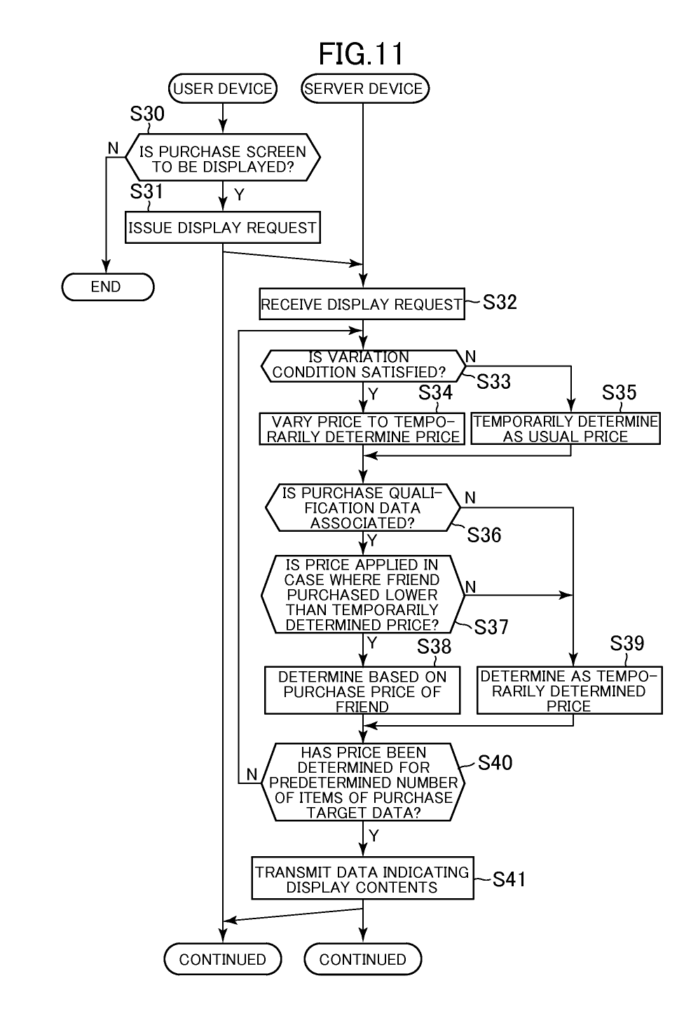

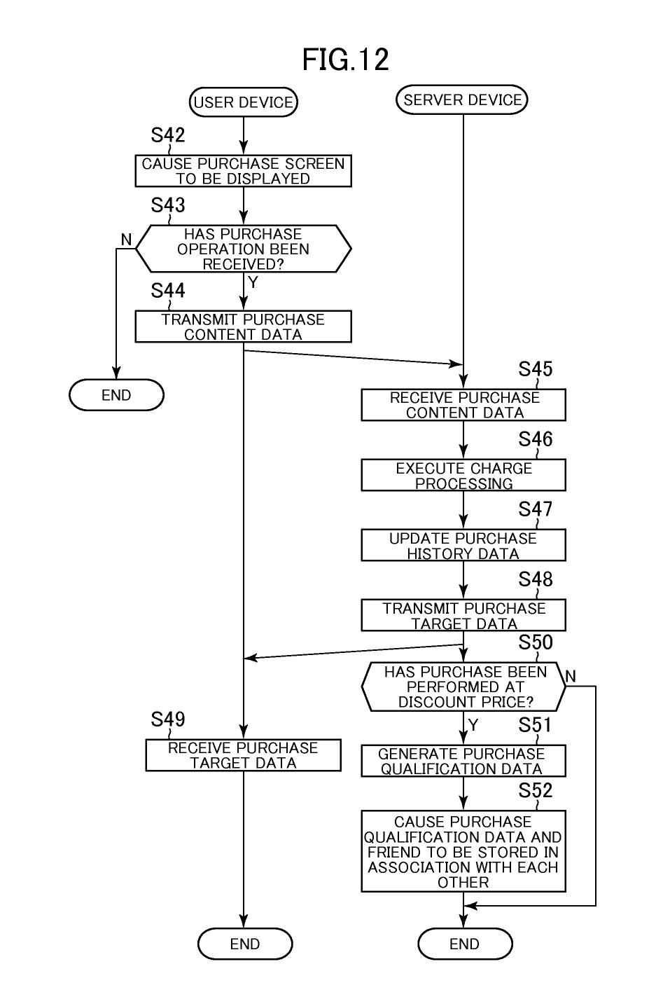

FIGS. 11 and 12 are diagrams illustrating a flow of processing performed in the price determination system S according to the second embodiment. In the second embodiment, the same processing as that of FIGS. 7 and 8 is executed.

As illustrated in FIG. 11, Steps S30 to S35 are the same processing as Steps S10 to S15, respectively, and hence descriptions thereof are omitted.

After the price of the purchase target data is temporarily determined in Step S34 or S35, the control unit 2 judges whether or not the purchase qualification data and the user who issued the display request in Step S31 are associated with each other (S36). In other words, it is judged in Step S36 whether or not the purchase qualification data indicating a qualification to purchase the purchase target data for which the price is currently being determined at the price determined by the price determination unit 34 is stored in association with the user who issued the display request in Step S31.

When it is judged that the purchase qualification data is associated (S36; Y), the user who issued the display request in Step S31 is qualified to purchase the purchase target data at the price determined by the price determination unit 34, and hence the processing advances to Step S37.

On the other hand, when it is not judged that the purchase qualification data is associated (S36; N), the user who issued the display request in Step S31 is not qualified to purchase the purchase target data at the price determined by the price determination unit 34, and hence the processing advances to Step S39.

The subsequent Steps S37 to S49 are the same as Steps S17 to S29, respectively, and hence descriptions thereof are omitted.

As a result of performing the processing of Steps S37 to S49, if the purchase target data is stored on the user device 10, the control unit 2 judges whether or not the user has purchased the purchase target data at the discount price (S50). In Step S50, for example, the judgment is performed by referring to the purchase target data that is indicated by the purchase content data received in Step S45 and the flag stored in the RAM of the storage unit 3 (flag indicating whether or not the price of the purchase target data is the discount price).

When it is not judged that the user has purchased the purchase target data at the discount price (S50; N), the processing is brought to an end. In other words, in this case, the user has purchased the purchase target data at the usual price, which does not mean that the friend of this user can purchase the purchase target data at a lower price, and hence the purchase qualification data is not generated.

When it is judged that the user has purchased the purchase target data at the discount price (S50; Y), the control unit 2 generates the purchase qualification data (S51). In Step S48, for example, the purchase qualification data including the data (price data) indicating the purchase price of the user that is stored in the RAM of the storage unit 3 and the data for identifying the purchase target data that was purchased by this user is generated.

Subsequently, the control unit 2 causes the storage unit 3 to store the purchase qualification data generated in Step S51 and the friend of the user who has purchased the purchase target data in association with each other (S52), and the processing is brought to an end. In Step S52, with reference to the user group data, the friend of the user who has purchased the purchase target data is identified. This identified friend is stored in the storage unit 3 in association with the purchase qualification data (see FIG. 10).

According to the price determination system S described above, by using the purchase qualification data, it is possible to judge whether or not the user who is going to purchase the purchase target data is qualified to purchase the purchase target data at the purchase price of the friend. Further, in the same manner as the first embodiment, a characteristic of the social networking service can be made the most of to increase the users who use the charging service.

Note that, the second embodiment is different from the first embodiment in that the purchase qualification data is generated at a time point at which the user purchases the purchase target data, and hence the friend of this user as of a purchased time point can be allowed to purchase the purchase target data at the purchase price of this user.

Further, the above description is directed to the case where the purchase qualification data includes the price data, but the purchase qualification data may be any data that indicates that the second user associated with the first user is qualified to purchase the purchase target data at the price determined by the price determination unit 34. In other words, the purchase qualification data may not necessarily include the price data.

For example, the purchase qualification data may include data indicating the price at which the second user can purchase the purchase target data. In other words, in execution of the processing of Step S51, the price determination unit 34 temporarily determines the price of the purchase target data based on the price data. The purchase qualification data including data indicating this determined price may be generated and stored in the purchase qualification data storage unit 38 in association with the friend.

Further, in the same manner as the first embodiment, the purchase enabled user number may be defined in advance. For example, when the number of friends of the user exceeds the purchase enabled user number, the friend associated with the purchase qualification data is determined based on a predetermined method. For example, the friend may be determined at random, or may be determined based on a parameter indicating a degree of familiarity with the friend, which is previously retained.

### 3. Third Embodiment

In the first embodiment and the second embodiment, the description is directed to the case where, for example, the purchase enabled user number is all or a predetermined number of the friends of the given user. A price determination system S according to a third embodiment is configured so that, for example, the purchase enabled user number varies based on the sales of the purchase target data. This technology is hereinafter described in detail.

[3-1. Functions Realized in Price Determination System According to Third Embodiment]

The server data storage unit 30 according to the third embodiment stores sales quantity data relating to a sales quantity (purchased quantity) of the purchase target data or a saleable quantity (quantity of inventory) of the purchase target data. In this embodiment, the description is directed to a case where the sales quantity data indicates the sales quantity of the purchase target data.

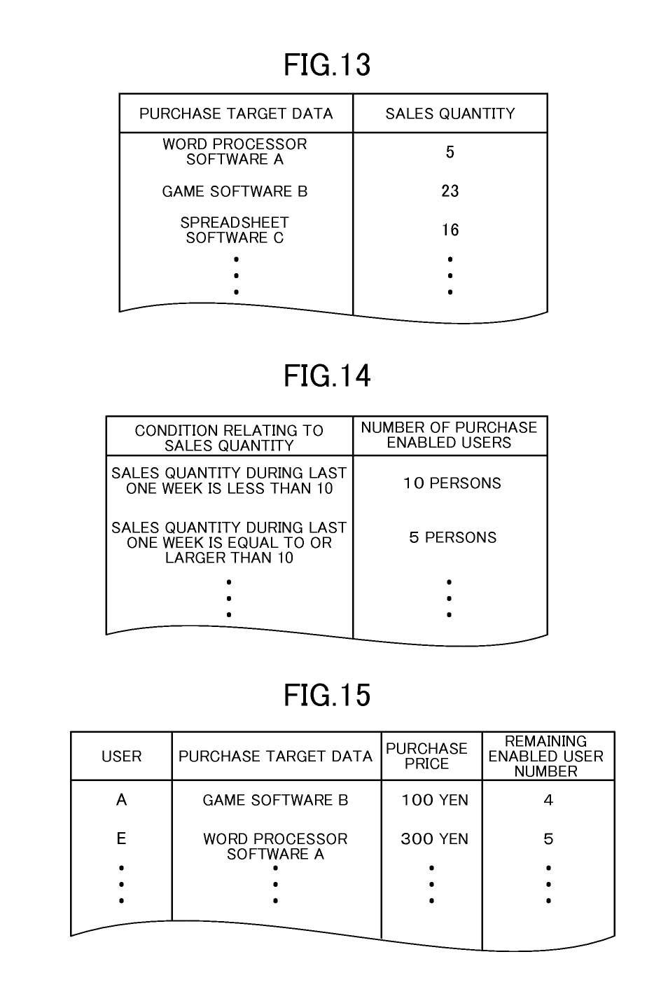

FIG. 13 is a diagram illustrating a data storage example of the sales quantity data. As illustrated in FIG. 13, the sales quantity data stores the data for identifying the purchase target data and data indicating the sales quantity of the purchase target data in association with each other. For example, the control unit 2 functions as means for updating the sales quantity indicated by the sales quantity data when the user purchases the purchase target data. In other words, when the user purchases the purchase target data, the sales quantity data is updated so as to increase the sales quantity indicated by the sales quantity data.

A time at which the control unit 2 updates the contents of the sales quantity data may be an arbitrary time after reception of the purchase operation performed by the user. For example, after the purchase target data is transmitted to the user device 10 in Step S28, the control unit 2 increments the sales quantity indicated by the purchase target data, to thereby update the sales quantity data.

Further, the price determination system S according to the third embodiment includes means for determining, based on the sales quantity or the saleable quantity indicated by the sales quantity data, the number (purchase enabled user number) of second users who can purchase the purchase target data at the price determined by the price determination unit 34. For example, it is judged whether or not the sales quantity or the saleable quantity indicated by the sales quantity data satisfies a predetermined condition relating to the sales quantity or the saleable quantity, and the purchase enabled user number is determined based on a judgment result thereof. In this embodiment, the description is directed to a case where, for example, data obtained by associating a condition relating to the sales quantity of the purchase target data with the purchase enabled user number is stored in the server data storage unit 30.

FIG. 14 is a diagram illustrating association between the condition relating to the sales quantity of the purchase target data and the purchase enabled user number. The condition relating to the sales quantity is, for example, a condition indicating whether or not the sales quantity during a predetermined period (for example, period from a predetermined time before the current time point until the current time point) falls within a predetermined range (for example, equal to or larger than a reference number). In a data storage example illustrated in FIG. 14, the number of purchase enabled users differs depending on whether or not the sales quantity during the last one week falls within a predetermined range (for example, equal to or larger than 10).

[3-2. Flow of Processing Performed in Price Determination System According to Third Embodiment]

Next, a flow of processing performed in the price determination system according to the third embodiment is described.

First described is a flow of processing performed in the price determination system S obtained by combining the third embodiment with the first embodiment. In this case, the processing having the same flow as illustrated in FIGS. 7 and 8 is executed. In a case where the third embodiment is applied to the first embodiment, for example, the purchase history data stores information relating to the remaining number of users who can purchase the purchase target data at the price determined by the price determination unit 34 (hereinafter referred to as “remaining purchase enabled user number”).

FIG. 15 is a diagram illustrating a data storage example of the purchase history data according to the third embodiment. As illustrated in FIG. 15, for example, the purchase history data stores the remaining purchase enabled user number. In Step S27 of the third embodiment, with reference to the sales quantity data and the data illustrated in FIG. 15, the remaining purchase enabled user number is stored in the purchase history data.

Specifically, for example, with reference to the sales quantity data, the sales quantity of the purchase target data that has been purchased by the user is identified. Subsequently, the purchase enabled user number associated with the condition satisfied by this identified sales quantity is stored in the purchase history data as the remaining purchase enabled user number.

The remaining purchase enabled user number decreases by one each time the friend purchases the purchase target data at the price determined by the price determination unit 34. In other words, when the friend purchases the purchase target data at the price determined by the price determination unit 34, the remaining purchase enabled user number decreases in Step S27. When the purchase enabled user number associated with the user who has purchased the purchase target data in the past falls within a predetermined range (for example, 0), the friend is inhibited from purchasing the purchase target data at the purchase price of this user.

Further, for example, in the third embodiment, in execution of the processing of Step 16, it is judged whether or not the remaining purchase enabled user number stored in the purchase history data is zero. When the remaining purchase enabled user number is not zero, the processing advances to Step S17. On the other hand, when the remaining purchase enabled user number is zero, the processing advances to Step S19.

Next described is a flow of processing performed in the price determination system S obtained by combining the third embodiment with the second embodiment. In this case, the processing having the same flow as illustrated in FIGS. 11 and 12 is executed. In a case where the third embodiment is applied to the second embodiment, for example, the number of friends associated with the purchase qualification data is determined based on the purchase enabled user number.

For example, in execution of the processing of Step S52, with reference to the sales quantity data and the data illustrated in FIG. 13, the purchase enabled user number is identified. In Step S52, the purchase enabled user number of friends among the friends of the user who have purchased the purchase target data are associated with the purchase qualification data. A method of associating the purchase qualification data in the case where the number of friends of the user exceeds the purchase enabled user number is the same as that of the second embodiment.

According to the price determination system of the third embodiment, the purchase enabled user number can be varied based on the sales of the purchase target data. For example, the purchase target data that is popular sells to some extent even after the limited time sale period ends, and hence an average sale per customer can be prevented from declining by reducing the purchase enabled user number. On the other hand, the purchase target data that has poor sales does not sell well after the limited time sale period ends, and hence the sales can be increased by increasing the purchase enabled user number.

Note that even in a case where the sales quantity data indicates the saleable quantity, the same processing as described above is executed. The saleable quantity is the number of users who can purchase the purchase target data. For example, by setting the saleable quantity of the purchase target data, it is possible to increase a rarity value of the purchase target data. In this case, the purchase enabled user number is determined by reading the above-mentioned “sales quantity” as “saleable quantity”.

### 4. Fourth Embodiment

In the first embodiment to the third embodiment, the description is directed to the case where, in the case where the user has purchased the purchase target data at the discount price, the friend of this user can purchase the purchase target data at the price determined by the price determination unit 34 at an arbitrary time point beyond the limited time sale period. The period during which the friend can purchase the purchase target data at the price determined by the price determination unit 34 may vary under a predetermined condition.

A price determination system according to a fourth embodiment is configured so that, for example, in the case where the user has purchased the purchase target data at the discount price, the period during which the friend can purchase the purchase target data at the purchase price of this user is determined based on the sales of this purchase target data.

[4-1. Functions Realized in Price Determination System According to Fourth Embodiment]

A price determination system S according to the fourth embodiment includes means for determining the period during which the second user can purchase the purchase target data at the price determined by the price determination unit 34 (hereinafter referred to as “purchase enabled period”) based on the sales quantity or the saleable quantity indicated by the sales quantity data. For example, it is judged whether or not the sales quantity or the saleable quantity indicated by the sales quantity data satisfies a predetermined condition relating to the sales quantity or the saleable quantity, and the purchase enabled period is determined based on a judgment result thereof. In this embodiment, the description is directed to a case where, for example, data obtained by associating the condition relating to the sales quantity of the purchase target data with the purchase enabled period is stored in the server data storage unit 30.

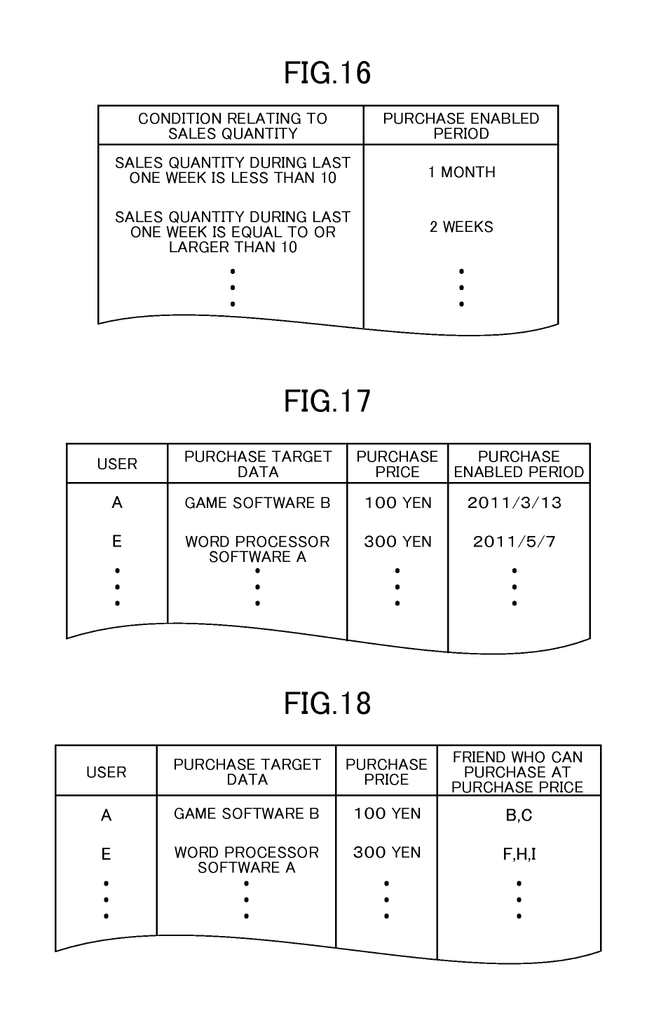

FIG. 16 is a diagram illustrating an association between the condition relating to the sales quantity of the purchase target data and the purchase enabled period. In a data storage example illustrated in FIG. 16, the purchase enabled period differs depending on whether or not the sales quantity during the last one week falls within the predetermined range (for example, equal to or larger than 10).

[4-2. Flow of Processing Performed in Price Determination System According to Fourth Embodiment]

Next, a flow of processing performed in the price determination system according to the fourth embodiment is described.

First described is a flow of processing performed in the price determination system S obtained by combining the fourth embodiment with the first embodiment. In this case, the processing having the same flow as illustrated in FIGS. 7 and 8 is executed. In a case where the fourth embodiment is applied to the first embodiment, for example, the purchase history data stores data relating to the purchase enabled period.

FIG. 17 is a diagram illustrating a data storage example of the purchase history data according to the fourth embodiment. As illustrated in FIG. 17, for example, the purchase history data stores the purchase enabled period. In Step S27 of the fourth embodiment, with reference to the sales quantity data and the data illustrated in FIG. 16, the purchase enabled period is stored in the purchase history data.

Specifically, for example, with reference to the sales quantity data, the sales quantity of the purchase target data that has been purchased by the user is identified. Subsequently, the purchase enabled period associated with the condition satisfied by this identified sales quantity is stored in the purchase history data. For example, a date that is the purchase enabled period after the current time point is stored as the purchase enabled period. After the lapse of the purchase enabled period, the user being the friend is inhibited from purchasing the purchase target data at the price determined by the price determination unit 34.

For example, in the execution of the processing of Step S16, the data indicating the current time point generated by a time function or the like is acquired, and it is judged whether or not the purchase enabled period stored in the purchase history data has elapsed. When it is judged that the purchase enabled period has not elapsed, the processing of Step S17 is executed. On the other hand, when it is judged that the purchase enabled period has elapsed, the processing advances to Step S19.

Next described is a flow of processing performed in the price determination system S obtained by combining the fourth embodiment with the second embodiment. In this case, the processing having the same flow as illustrated in FIGS. 11 and 12 is executed. In a case where the fourth embodiment is applied to the second embodiment, in the fourth embodiment, for example, data indicating the purchase enabled period is stored in the purchase qualification data.

For example, in the execution of the processing of Step S51, with reference to the sales quantity data and the data illustrated in FIG. 16, the purchase enabled period is identified. The purchase qualification data including data indicating this identified purchase enabled period is generated and stored in association with the friend.

Further, in Step S36, with reference to the purchase enabled period of the purchase qualification data stored on the user device 10, it is judged whether or not the current time point falls within the purchase enabled period. When it is judged that the current time point falls within the purchase enabled period, the processing advances to Step S37. When it is not judged that the current time point falls within the purchase enabled period, the processing advances to Step S39.

According to the price determination system of the fourth embodiment, the purchase enabled period can be varied based on the sales of the purchase target data. For example, the purchase target data that is popular may sell fast even at the usual price, and hence the average sale per customer can be prevented from declining by shortening the purchase enabled period. On the other hand, the purchase target data that has poor sales hardly sells at the usual price, and hence the sales can be increased by prolonging the purchase enabled period.

Note that even in the fourth embodiment, in the same manner as in the third embodiment, the same processing as described above is also executed in the case where the sales quantity data indicates the saleable quantity. The purchase enabled user number is determined by reading the above-mentioned “sales quantity” as “saleable quantity”.

### 5. Fifth Embodiment

A price determination system according to a fifth embodiment is configured, in addition to the functions according to the first embodiment to the fourth embodiment, so that when the friend purchases the purchase target data at the purchase price of the user, for example, this user receives a reward (for example, cashback). This technology is hereinafter described in detail.

[5-1. Functions Realized in Price Determination System According to Fifth Embodiment]

A price determination system S according to the fifth embodiment includes means for executing processing for giving a reward to the first user associated with the second user when the second user purchases the purchase target data at the price determined by the price determination unit 34.

The reward given to the user is, for example, a payoff of cash or virtual currency (cashback), the purchase target data, a product, a service, or the like. The processing for giving a reward to the user is, for example, payoff processing that allows the user to receive cash or virtual currency, processing for delivering the purchase target data to the user, determination processing for a product to be received by the user, or determination processing for a service to be provided to the user.

[5-2. Flow of Processing Performed in Price Determination System According to Fifth Embodiment]

In the fifth embodiment, the same processing as that of FIGS. 7 and 8 or that of FIGS. 11 and 12 is executed. For example, after the processing of Step S28 or S52 is executed, with reference to the purchase history data or the purchase qualification data, the user to be given the reward is identified. The server device 1 executes the processing that allows this user to receive the reward.

The reward to be given to the user is determined based on a predetermined method. For example, the reward to be given to the user may be determined based on a difference between the current price of the purchase target data and the purchase price of the friend. For example, as this difference becomes larger, a higher reward may be given to the user (for example, cashback becomes more).

According to the price determination system of the fifth embodiment, in the case where the given user has purchased the purchase target data, when the friend purchases at the purchase price of this user, this user is given the reward, which can promote a buying motive of the user and can increase the users who use a charge system.

### 6. Sixth Embodiment

The price determination system according to a sixth embodiment is configured, in addition to the functions according to the first embodiment to the fifth embodiment, so that the friend who can purchase the purchase target data at the purchase price of a given user can be designated by the given user. This technology is hereinafter described in detail.

[6-1. Functions Realized in Price Determination System According to Sixth Embodiment]

A price determination system S according to the sixth embodiment includes means for receiving a designation of a second user performed by the first user from among the second users associated with the first user. For example, a screen (not shown) including a list of the friends of the first user is displayed on the display unit 15, and the designation performed by the first user is received. In other words, the designation of the friend who can purchase the purchase target data at the price determined by the price determination unit 34 among the friends of the first user is received.

The price determination unit 34 determines the price of the purchase target data which is applied in a case where the second user designated by the first user from among the second users associated with the first user purchases the purchase target data, based on the price of the purchase target data (in other words, price data) which was applied in the case where the first user purchased the purchase target data. In other words, the price of the purchase target data which is applied in the case where the second user that is not designated by the first user, from among the second users associated with the first user, purchases the purchase target data is inhibited from being determined based on the price data.

Note that the price determination unit 34 acquires data for identifying the second user designated by the first user from the means for receiving the designation performed by the first user (for example, operation unit 13 of the user device 10). For example, the price determination unit 34 acquires the data for identifying the second user designated by the first user from the user device 10 via the network N.

[6-2. Flow of Processing Performed in Price Determination System According to Sixth Embodiment]

Next, a flow of processing performed in the price determination system according to the sixth embodiment is described.

First described is a flow of processing performed in the price determination system S obtained by combining the sixth embodiment with the first embodiment. In this case, the processing having the same flow as illustrated in FIGS. 7 and 8 is executed. In a case where the sixth embodiment is applied to the first embodiment, for example, the purchase history data stores data indicating the second user designated by the first user.

FIG. 18 is a diagram illustrating a data storage example of the purchase history data according to the sixth embodiment. As illustrated in FIG. 18, for example, the purchase history data stores data for identifying a friend (second user). For example, when the user purchases the purchase target data having the discount price, after Step S28 is executed, data indicating the list of the friends of the user is generated and transmitted to the user device 10.

On the user device 10, the screen indicating the list of the friends is displayed, and the designation of the friend performed by the user is received. Based on operation content of the user, the data indicating the friend designated by the user is transmitted to the server device 1. On the server device 1, this acquired data is stored in the purchase history data.

Further, for example, in the execution of the processing of Step S16 according to the sixth embodiment, it is judged whether or not the data indicating the user who issued the display request in Step S11 is stored in the purchase history data. In other words, it is judged whether or not the user who issued the display request is designated by the friend. When it is judged that the user is designated, the processing of Step S17 is executed. On the other hand, when it is not judged that the user is designated, the processing advances to Step S19.

Next described is a flow of processing performed in the price determination system S obtained by combining the sixth embodiment with the second embodiment. In this case, the processing having the same flow as illustrated in FIGS. 11 and 12 is executed. In a case where the sixth embodiment is applied to the second embodiment, for example, the purchase qualification data is associated only with the second user designated by the first user.

For example, in the execution of the processing of Step S51, the designation performed by the first user is received. This receiving method is the same as in the case where the sixth embodiment is applied to the first embodiment. The purchase qualification data is delivered to the user device 10 operated by this designated second user.

According to the price determination system of the sixth embodiment, the friend who can purchase the purchase target data at the purchase price of a given user can be designated by the given user. The friend who can purchase at the discount price can be chosen from among the friends of the user who have purchased the purchase target data, which can prevent such an act of receiving from another user a request to become friends therewith the intention of purchasing the purchase target data at a lower price.

### 7. Modified Examples

Note that the present invention is not limited to the above-mentioned embodiments, and may be variously modified without departing from the spirit of the present invention.

(1) For example, in the above-mentioned embodiments, the description is directed to the case where the price varying unit 32 varies the price of the purchase target data so that the price of the purchase target data becomes lower during the limited time sale period, but a method of varying the price of the purchase target data performed by the price varying unit 32 is not limited to the examples of the embodiments. For example, the price of the purchase target data may be varied with reference to the latest purchase target master data set by a system administrator.

In addition, for example, the variation condition for changing the price of the purchase target data may not be such a condition relating to the current time point as described in the embodiments. For example, the price varying unit 32 may vary the price of the purchase target data based on the sales quantity (or sales amount) or the saleable quantity of the purchase target data. For example, the condition relating to the sales quantity or the saleable quantity of the purchase target data and information relating to the price of the purchase target data may be previously stored in association with each other.

In this case, the price is varied to the price associated with the condition satisfied by the sales quantity of the purchase target data. For example, the user may be notified of a remaining sales quantity necessary for the current sales quantity of the purchase target data to reach a predetermined number. Note that in the information relating to the price associated with the sales quantity or the saleable quantity of the purchase target data, the price itself may be stored, or a price increase rate/price decrease rate of the price of the purchase target data may be stored.

For example, the price of the purchase target data varies so that the price becomes higher as the sales quantity of the purchase target data becomes larger. In this case, a unit price of the purchase target data exhibiting a large sales quantity becomes higher, which can increase the sales. Further, for example, the price may be lowered as the sales quantity of the purchase target data becomes larger. In this case, for example, the price can be lowered as the friends purchase more items of purchase target data.

Further, for example, a predetermined price is set at a time point at which the purchase target data goes on sale, and the price of the purchase target data may be varied based on a time required until the sales quantity of the purchase target data satisfies the condition relating to the sales quantity. In this case, information relating to the time required until the sales quantity of the purchase target data satisfies the condition relating to the sales quantity and the information relating to the price of the purchase target data may be previously stored in association with each other.

For example, the price of the purchase target data varies so that the price becomes higher as the time required until the sales quantity of the purchase target data satisfies the condition relating to the sales quantity becomes shorter. In this case, the unit price of the purchase target data that is popular becomes higher, which can increase the sales. Further, for example, the price may be lowered as the time required until the sales quantity of the purchase target data satisfies the condition relating to the sales quantity becomes shorter. In this case, for example, the price can be lowered as the friends purchase more items of purchase target data during a predetermined period.

Further, in the embodiments, the description is directed to the case where, for example, one price is associated with one item of purchase target data, but one price may be associated with a plurality of items of purchase target data. In other words, in this case, the plurality of items of purchase target data are sold as one set. The price varying unit 32 may vary the price of this one set.

(2) Further, in the embodiments, the description is directed to the case where, for example, the data (purchase history data or purchase qualification data) stored on the server device 1 is used to thereby judge whether or not the given user is qualified to purchase the purchase target data at the purchase price of the friend. A method for this judgment processing is not limited to the examples of the embodiments. In addition, for example, this judgment processing may be performed based on the data stored on the user device 10.

For example, when the first user purchases the purchase target data, the purchase qualification data generation unit 36 refers to the user group data to identify the second user associated with this first user. The generated purchase qualification data is delivered to the user device 10 operated by this identified second user. For example, the generated purchase qualification data and data for identifying the second user to which the purchase qualification data is to be delivered are previously stored in the server data storage unit 30 in association with each other, and when this second user accesses the server device 1, this purchase qualification data is delivered thereto.

In this case, the purchase qualification data storage unit 38 is realized by the storage unit 12 of the user device 10. For example, on the user device 10, the purchase qualification data is acquired from the purchase qualification data generation unit 36 via the network N, and the acquired purchase qualification data is stored in the purchase qualification data storage unit 38.

Further, the price determination unit 34 according to this modified example judges whether or not the purchase qualification data is acquired from the purchase qualification data storage unit 38 of the user device 10 operated by the second user, to thereby judge whether or not the second user is qualified to purchase the purchase target data at the price determined by the price determination unit 34.

In this modified example, the processing having the same flow as illustrated in FIGS. 11 and 12 is executed. However, for example, in execution of Step S31, the control unit 11 judges whether or not the purchase qualification data is stored in the storage unit 12.

When it is not judged that the purchase qualification data is stored, which means that the friend (first user) of the user (second user) has not purchased the purchase target data in the past, the processing of Steps S36 to S39 is not executed. In other words, when not acquiring the purchase qualification data from the user device 10, the server device 1 does not execute the processing of Steps S36 to S39. Accordingly, in the processing of Steps S35 and S36, the price of the purchase target data is determined instead of being temporarily determined.

On the other hand, when it is judged that the purchase qualification data is stored, Steps S31 to S52 are executed. However, in Step S31, the control unit 11 transmits the display request for the purchase screen 20 and the purchase qualification data stored in the storage unit 12 to the server device 1. Further, in Step S32, the control unit 2 receives the display request for the purchase screen 20 and the purchase qualification data, and temporarily stores the display request for the purchase screen 20 and the purchase qualification data in the RAM or the like of the storage unit 3.

Further, the control unit 2 judges in Step S36 whether or not the purchase target data that is currently being subjected to the determination processing for the price is the purchase target data indicated by the purchase qualification data received in Step S32. When the purchase target data is judged as being the purchase target data indicated by the purchase qualification data, the processing advances to Step S37. When the purchase target data is not judged as being the purchase target data indicated by the purchase qualification data, the processing advances to Step S39.

Further, in Step S52, the control unit 2 delivers the purchase qualification data generated in Step S51 to the friend of the user who has purchased the purchase target data. In Step S52, with reference to the user group data, the friend of the user who has purchased the purchase target data is identified, and the purchase qualification data is transmitted to the user device 10 operated by this friend. Note that on the user device 10 of the friend who has received the purchase qualification data, the received purchase qualification data is stored in the storage unit 3. The friend can use this received purchase qualification data next time they purchase the purchase target data.

Further, the purchase qualification data is stored on the user device 10 of each user, and hence, for example, even without the limited time sale period, the user can grasp whether or not they can purchase the purchase target data at a lower price by referring to the purchase qualification data stored on the user device 10 without having to access the server device 1.

Further, for example, the purchase qualification data may include a predetermined character string (for example, coupon code). This predetermined character string may be used to prove that the second user is qualified to purchase the purchase target data at the purchase price of the first user. For example, when generating the purchase qualification data including the predetermined character string, the purchase qualification data generation unit 36 causes the server data storage unit 30 to store the predetermined character string. In the case where the second user purchases the purchase target data, the character string stored in the purchase qualification data may be compared with the character string stored on the server data storage unit 30, to thereby judge (authenticate) whether or not this second user is qualified to purchase the purchase target data at the purchase price of the first user.

(3) Further, in the embodiments, the description is directed to the case where the purchase target data is application software data, but the purchase target data may be any data that is to be purchased by the user. For example, the purchase target data may be image data, video data, or audio (music track) data.

In addition, for example, the purchase target data may be data indicating an item (charging item) to be used in a game that uses the social networking service.

In this case, for example, the user operates the user device 10 to play the game with the aim of causing a predetermined game event to occur. For example, the friend is notified of a game progress status of the given user. For example, when the user causes the predetermined game event to occur, a notification is issued to this user and the friend.

For example, in a case where the charging item purchased by the user is used in the game, a value of a game parameter changes. Further, for example, in the case where the charging item purchased by the user is used in the game, an occurrence probability of the game event may change. The price determination system S may determine the price of the charging item to be used in the game.

Further, for example, the purchase target data may be data indicating the game event. In this case, only the charged user can cause the predetermined game event to occur. In addition, for example, the purchase target data may be data indicating a character that is to appear in the game. In this case, only the charged user can use a predetermined character.

(4) Further, the description is directed to the case where actual currency is charged on the user when the charge processing is executed on the user who has purchased the purchase target data, but the virtual currency exchanged within the social networking service may be charged. In this case, the user previously pays the actual currency (for example, yen) to purchase the virtual currency (for example, points). In the case where the user purchases the purchase target data, the charge processing of the virtual currency is executed. In other words, the price determination system S may determine the price of the purchase target data in terms of the virtual currency.

(5) Further, in the embodiments, the description is directed to the case where the price varying unit 32 is realized by the server device 1, but the price varying unit 32 may be realized by the user device 10. In this case, the user device 10 may acquire the purchase target master data from the server device 1 via the network N, or the purchase target master data may be previously stored in the storage unit 12.

In this case, in the case where the user purchases the purchase target data, the price is varied with reference to the purchase target master data. In other words, it is judged whether or not the variation condition stored in the purchase target master data is satisfied, to thereby vary the price associated with the variation condition. Data indicating this varied price may be transmitted to the server device 1 via the network N.

Further, in the embodiments, the description is directed to the case where the price determination unit 34 is realized by the server device 1, but the price determination unit 34 may be realized by the user device 10. In this case, the user device 10 may acquire the price data from the server device 1 via the network N, or the price data may be previously stored in the storage unit 12. Data indicating the price determined by the price determination unit 34 may be transmitted to the server device 1, to thereby execute the charge processing on the user.

Further, in the second embodiment, the description is directed to the case where the purchase qualification data generation unit 36 is realized by the server device 1, but the purchase qualification data generation unit 36 may be realized by the user device 10. In this case, the user device 10 stores information (for example, user data) for identifying the user device 10 of the friend, and delivers the generated purchase qualification data to the user device 10 of the friend. Alternatively, the user device 10 transmits the generated purchase qualification data to the server device 1, and the server device 1 identifies the friend of the user to deliver the purchase qualification data to the friend.

(6) Further, for example, the description is directed to the case where a given user is associated with the friend thereof based on the user group data, but may be associated with another user based on the user group data. In addition, for example, a friend of the friend of the user may be associated, or a user participating in a community relating to a particular topic may be associated.

(7) Further, the above-mentioned embodiments and the modified examples are described by taking the purchase target data as an example of a purchase target of the user, but in the price determination system S, it suffices that the price of what is to be the purchase target of the user is determined. In addition, for example, the price of the product or the service to be given to the user may be determined. In this case, for example, the same processing as those of the embodiments and the modified examples may be realized by reading the above-mentioned “purchase target data” as “product or service”.

1. A price determination system, comprising:
price varying means for varying a current price of purchase target data that is to be purchased by a user;
means for acquiring user group data obtained by associating a first user with a second user from means for storing the user group data; and
price determination means for determining, in a case where the first user has purchased the purchase target data, a different price from the current price of the purchase target data which is varied by the price varying means, as a price of the purchase target data which is applied in a case where the second user associated with the first user purchases the purchase target data, based on a price of the purchase target data which was applied in a case where the first user purchased the purchase target data.

2. The price determination system according to claim 1, wherein:
the price determination means comprises price comparison means for comparing, in the case where the second user purchases the purchase target data, the price determined based on the price of the purchase target data which was applied in the case where the first user purchased the purchase target data with the current price of the purchase target data which is varied by the price varying means; and
when the current price of the purchase target data which is varied by the price varying means is higher than the price determined based on the price of the purchase target data which was applied in the case where the first user purchased the purchase target data, the price determined based on the price of the purchase target data which was applied in the case where the first user purchased the purchase target data is determined as the price of the purchase target data which is applied in the case where the second user associated with the first user purchases the purchase target data.

3. The price determination system according to claim 1, further comprising:
means for acquiring sales quantity data relating to a sales quantity or a saleable quantity of the purchase target data from means for storing the sales quantity data; and
means for determining a number of second users who are allowed to purchase the purchase target data at the price determined by the price determination means, based on the sales quantity or the saleable quantity indicated by the sales quantity data.

4. The price determination system according to claim 1, further comprising:
means for acquiring sales quantity data relating to a sales quantity or a saleable quantity of the purchase target data from means for storing the sales quantity data;
means for determining a period during which the second user is allowed to purchase the purchase target data at the price determined by the price determination means, based on the sales quantity or the saleable quantity indicated by the sales quantity data.

5. The price determination system according to claim 1, further comprising means for executing processing for giving a reward to the first user associated with the second user in the case where the second user purchases the purchase target data at the price determined by the price determination means.

6. The price determination system according to claim 1, further comprising means for receiving a designation of a second user by the first user from among the second users associated with the first user,
wherein the price determination means determines the price of the purchase target data which is applied in the case where the second user designated by the first user from among the second users associated with the first user purchases the purchase target data, based on the price of the purchase target data which was applied in the case where the first user purchased the purchase target data.

7. The price determination system according to claim 1, further comprising means for acquiring purchase history data indicating a purchase history of the purchase target data by the first user from means for storing the purchase history data, wherein:
the price determination means comprises judgment means for judging, based on the purchase history data, whether or not, in the case where the second user purchases the purchase target data, the first user associated with the second user has purchased the purchase target data in the past; and
when the first user associated with the second user has purchased the purchase target data in the past, the price determined based on the price of the purchase target data which was applied in the case where the first user purchased the purchase target data is determined as the price of the purchase target data which is applied in the case where the second user associated with the first user purchases the purchase target data.

8. The price determination system according to claim 1, further comprising purchase qualification generation means for generating, in the case where the first user has purchased the purchase target data, purchase qualification data indicating that the second user associated with the first user is qualified to purchase the purchase target data at the price determined by the price determination means, and causing purchase qualification data storage means to store the purchase qualification data, wherein:
the price determination means comprises judgment means for judging whether or not the purchase qualification data is stored in the purchase qualification data storage means in the case where the second user associated with the first user purchases the purchase target data; and
when the purchase qualification data is stored in the purchase qualification data storage means, the price determined based on the price of the purchase target data which was applied in the case where the first user purchased the purchase target data is determined as the price of the purchase target data which is applied in the case where the second user associated with the first user purchases the purchase target data.

9. A control method for a price determination system, the control method comprising:
a price varying step of varying a current price of purchase target data that is to be purchased by a user;
a step of acquiring user group data obtained by associating a first user with a second user from means for storing the user group data; and
a price determination step of determining, in a case where the first user has purchased the purchase target data, a different price from the current price of the purchase target data which is varied in the price varying step, as a price of the purchase target data which is applied in a case where the second user associated with the first user purchases the purchase target data, based on a price of the purchase target data which was applied in a case where the first user purchased the purchase target data.

10. A program for causing a computer to function as:
price varying means for varying a current price of purchase target data that is to be purchased by a user;
means for acquiring user group data obtained by associating a first user with a second user from means for storing the user group data; and
price determination means for determining, in a case where the first user has purchased the purchase target data, a different price from the current price of the purchase target data which is varied by the price varying means, as a price of the purchase target data which is applied in a case where the second user associated with the first user purchases the purchase target data, based on a price of the purchase target data which was applied in a case where the first user purchased the purchase target data.

11. A non-transitory computer-readable information storage medium having the program according to claim 10 recorded thereon.

12. A price determination system, comprising:
price varying means for varying a current price of a product or a service that is to be purchased by a user;
means for acquiring user group data obtained by associating a first user with a second user from means for storing the user group data; and
price determination means for determining, in a case where the first user has purchased the product or the service, a different price from the current price of the product or the service which is varied by the price varying means, as a price of the product or the service which is applied in a case where the second user associated with the first user purchases the product or the service, based on a price of the product or the service which was applied in a case where the first user purchased the product or the service.
